(19) United States
(12) Patent Application Publication
(10) Pub. No.: US 2019/0262837 A1
(43) Pub. Date: Aug. 29, 2019

(54) GAP ADJUSTING SYSTEM FOR A DISC MILL ASSEMBLY OF A REDUCING MACHINE

(71) Applicant: ORENDA AUTOMATION TECHNOLOGIES INC., Markham (CA)

(72) Inventor: Hristos Lefas, Toronoto (CA)

(21) Appl. No.: 15/903,277

(22) Filed: Feb. 23, 2018

(51) Int. Cl. B02C 7/14; B02C 7/08; B02C 25/00

(52) U.S. Cl. CPC B02C 7/14; B02C 9/04; B02C 25/00; B02C 7/08

(57) ABSTRACT

A disc mill assembly of a reducing machine has a housing for housing a first stationary cutting disc in operative interaction with a second rotating cutting disc and separated therefrom by a relative gap distance. The stationary disc is fixed to a housing lid of the housing and the rotating disc is rotatably fixed to a housing body. The relative gap distance between the cutting discs is adjustable by adjusting mechanisms adjusting a relative housing distance between the housing lid and the housing body. A particle size detection analyzer detects the size of particles emanating from the disc mill assembly to generate a detection signal which may be used by the controller to obtain a desired particle size distribution.

### FIELD OF THE INVENTION

The invention relates to the field of reducing machines and in particular pulverizing machines. More particularly, the present invention relates to a mechanism to adjust the gap distance between discs in a disc mill assembly for use in such machines.

### BACKGROUND OF THE INVENTION

In the past, reducing machines, including pulverizing systems, have used disc mill assemblies to grind, shred or pulverize various types of materials into smaller particles. Such machines find particular application to grind pelletized or shredded plastics, nylons, polyesters and other polymers into powder or particles of predetermined size. However, it is understood that the invention may also be useful in other applications.

Reducing machines with one, or more, disc mill assemblies with relative moving discs have been known in the art for some time. In general, such a disc mill assembly will have discs with cooperating cutting surfaces to permit the grinding or reduction of the input material to a preferred size. Such a preferred size would depend on a number of factors, including the relative gap distance between the discs in the disc mill assembly.

In the past, the gap distance between the discs could be adjusted by manually rotating adjustable spacers and/or other attaching hardware for the discs. In some cases, an operator must repetitively loosen the attaching hardware of the disc mill assembly to permit access to, and manual adjustment of, the relative distance or gap between the discs. In some cases, adjusting knobs may be present on the exterior of the disc mill assembly. For safety reasons, the disc mill assembly is generally stopped to permit such manual adjustment. This involves loss of time and corresponding loss of production while the gap distance between the discs in the disc mill assembly is being adjusted.

Feeler gauges have been used in the past to determine the gap distance around the outer edge of the discs. Once it is determined that the gap between the discs needs to be changed, the adjustment is performed manually.

Furthermore, once the gap distance has been adjusted, the prior art mill assemblies are reconstituted and material may be reduced again. The particle size can then be measured. If the particle size is still not desirable, the adjustment must be repeated. Significant down time of the reducing system may be associated with this trial and error type of adjustment, until the desired particle size, and corresponding gap distance, is obtained.

Accordingly, there is a need in the art for an improved disc mill assembly in a reducing system which provides for more efficient adjustment of the gap between the discs. There is also a need in the art for a more efficient manner to continuously monitor and adjust the disc mill assemblies to ensure that the desired gap is obtained and maintained for a particular desired particle size.

### SUMMARY OF THE INVENTION

Accordingly, it is an object of this invention to at least partially overcome some of the disadvantages of the prior art. In particular, an object of the present invention is to provide an improved type of disc mill assembly for use in a reducing machine, and in particular a pulverizing machine, which may permit more efficient adjustment of the gap between the discs.

Accordingly, in one of its aspects, this invention resides in a disc mill assembly of a reducing apparatus, said disc mill assembly comprising: a disc mill housing for housing a first disc having a first cutting surface and a second disc having a second cutting surface, said first cutting surface separated from said second cutting surface by a relative gap distance along a longitudinal axis, said first cutting surface in operative interaction with the second cutting surface to reduce input material, said disc mill housing having a first part, operable to be connected to the first disc, and a second part a constant position and distance from the second cutting surface of the second disc; at least one adjusting mechanism associated with the housing for adjusting a relative housing distance along the longitudinal axis of the first part with respect to the second part in response to a gap adjusting signal; a controller for sending the gap adjusting signal to each of the adjusting mechanisms; and wherein the controller sending the gap adjusting signal to each of the adjusting mechanisms causes each of the adjusting mechanisms to adjust the relative housing distance between the first part and the second part to thereby adjust the relative gap distance between the first cutting surface and the second cutting surface.

In a further aspect, the present invention resides in a disc mill assembly of a reducing apparatus, said disc mill assembly having a housing with a housing lid operable to be connected to a stationary disc and a housing body operable to be rotatably connected to a rotating disc in operative interaction to the stationary disc and separated therefrom by a relative gap distance along a longitudinal axis to reduce input material there between, a gap adjusting system for adjusting the relative gap distance, said gap adjusting system comprising: at least one adjusting mechanism for adjusting a relative housing distance between the housing lid and the housing body along the longitudinal axis in response to a gap adjusting signal; a controller for sending the gap adjusting signal to each of the at least one adjusting mechanism causing the at least one adjusting mechanism to substantially synchronously adjust the relative housing distance between the housing lid and the housing body to adjust the relative gap distance between the stationary disc and the rotating disc.

Accordingly, in at least one aspect, an advantage of the present invention is that the relative gap distance between the grinding discs may be adjusted using the gap adjusting mechanism without the need to disassemble the disc mill assembly. In other words, a signal may be sent to the adjusting mechanisms from the controller to adjust the relative gap distance. This may improve the efficiency of the reducing machine by permitting the gap distance to be adjusted more quickly, thereby improving the output of the overall reducing machine by decreasing downtime required to adjust the gap distance between the discs.

A further advantage of at least some aspects of the present invention is that the signal to adjust the adjusting mechanism may be sent from a central controller. In this way, the gap is based on a user selected desired gap distance.

In at least some aspects of the present invention, a still further advantage is that the controller to control the relative gap distance between the discs may receive input from a particle size distribution analyzer which monitors the particle size of the output from the disc mill assembly. This permits the controller, in a preferred embodiment, to determine from the signal received from the particle size distribution analyzer whether or not the relative gap distance between the discs is producing the desired particle size output. In this way, closed loop control may be provided in that users of the gap adjusting mechanism can set a desired particle size, rather than a desired gap distance, and the controller will adjust the relative gap distance between the discs to attempt to produce the desired particle size, as determined by the particle distribution analyzer.

Further aspects of the invention will become apparent upon reading the following detailed description and drawings, which illustrate the invention and preferred embodiments of the invention.

### BRIEF DESCRIPTION OF THE DRAWINGS

In the drawings, which illustrate embodiments of the invention:

FIG. 1A is a schematic drawing showing an overall reducing machine, including the disc mill assembly, with a portion of the disc mill housing cut-out for ease of illustration according to one embodiment of the present invention;

FIG. 1B is an enlarged view of the disc mill assembly shown in FIG. 1A;

FIG. 2 illustrates a mill assembly according to one preferred embodiment of the present invention with a quarter section of the disc mill assembly removed for ease of illustration according to one preferred embodiment;

FIG. 3 show a top perspective view of the disc mill housing showing the adjusting mechanisms attached to the housing according to one preferred embodiment;

FIG. 4A show a cross sectional view of an adjusting mechanism attached to a disc mill housing in a first position according to one preferred embodiment having a pneumatically actuated piston;

FIG. 4B shows a cross sectional view of the adjusting mechanism shown in FIG. 4A in a second position;

FIG. 4C shows a cross sectional view of an adjusting mechanism attached to a disc mill housing in a further preferred embodiment having a servo motor;

FIG. 5 illustrates a sample output of a particle size detection analyzer showing the detected size of particles.

### DETAILED DESCRIPTION OF THE PREFERRED EMBODIMENTS

Preferred embodiments of the invention and its advantages can be understood by referring to the present drawings. In the present drawings, like numerals are used for like and corresponding parts of the accompanying drawings.

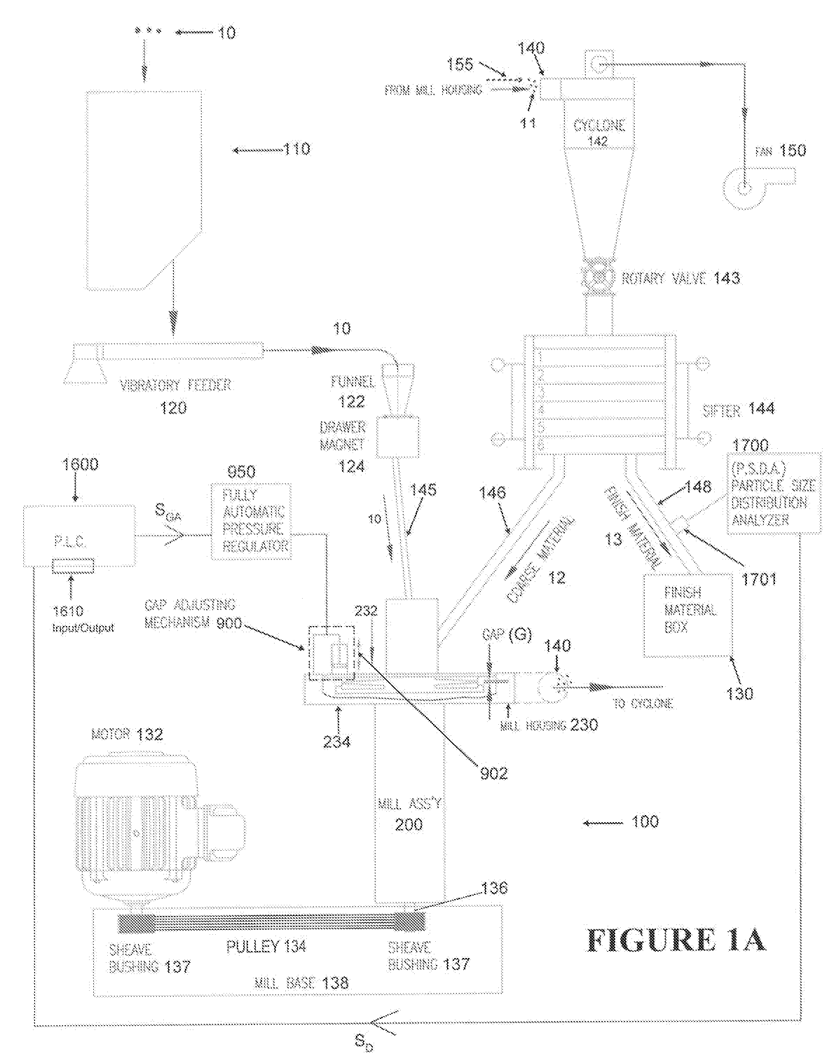

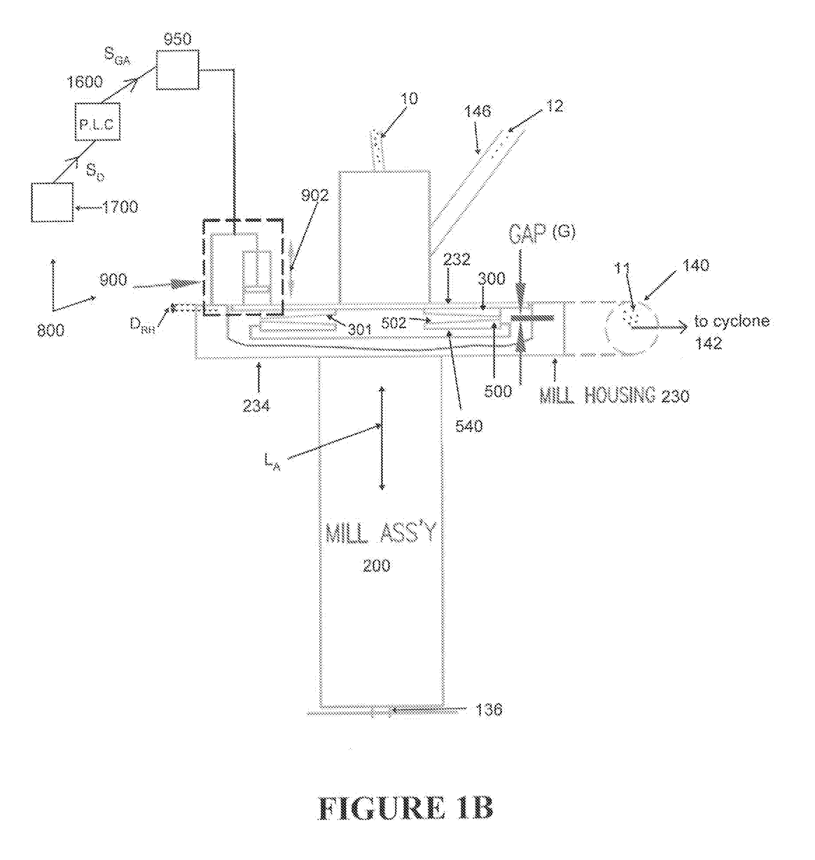

As shown in FIG. 1A, in one embodiment of the present invention, there is provided a reducing machine or apparatus, shown generally by reference numeral 100, for reducing input material, shown generally by reference numeral 10. The input material 10 is generally held in a hopper 110, which, in one embodiment, leads to a vibratory feeder 120 that allows the input material 10 to fall into a funnel 122. The funnel 122, in a preferred embodiment, has a drawer magnet 124 which permits flow of the input material 10 through the input material chute 145 to the disc assembly, as shown generally by reference numeral 200.

The mill assembly 200 comprises, in a preferred embodiment, a mill housing 230, and, for ease of illustration, the mill housing 230 is shown in cut-out in FIG. 1A and FIG. 1B. FIG. 1B is an enlarged view of the disc mill assembly 200 shown in FIG. 1A. The mill housing 230 houses a first disc, which in a preferred embodiment is a stationary disc 300, and a second disc, which in a preferred embodiment is a rotating disc 500. The first disc 300 has a first cutting surface 301 and the second disc 500 has a second cutting surface 502 which faces the first cutting surface 301 in operative interaction therewith to reduce the input material 10. In particular, relative rotation of the first disc 300 with respect to the second disc 500 reduces the input material 10 between the cutting surfaces 301, 502 to produce the reduced material 11.

As illustrated in FIGS. 1A and 1B, the first disc 300 and the second disc 500 are separated by a relative gap distance, shown generally by symbol G. Adjusting this relative gap distance G between the first disc 300 and the second disc 500, separating the first cutting surface 301 from the second cutting surface 502, will adjust the particle size of the reduced material 11 emanating from the disc mill assembly 200 and the reducing apparatus 100 as a whole.

In addition, as illustrated in FIGS. 1A and 1B, in a preferred embodiment, the disc mill housing 230 has a first part, which in a preferred embodiment may be considered a housing lid 232, operable to be connected to the first disc 300, which in this embodiment is the stationary disc 300. As illustrated in FIGS. 1A and 1B, the mill housing 230 also has a second part, which in a preferred embodiment, may be considered a housing body 234, but it is understood the second part may be any part which is a known constant distance from the second disc 500 and in particular the second cutting surface 502 of the rotating disc 500. For instance, in cases where the second disc is a rotating disc, the second part/housing body 234 may be any part of the of the disc mill assembly 200 that is rotatably fixed to the disc 500.

As discussed more fully below, a gap adjusting mechanism 900, shown schematically in FIGS. 1A and 1B by a dashed rectangle, is operable to adjust a relative housing distance (identified generally by reference numeral D_{RH} in FIG. 1B) of the first part 232 with respect to the housing part 234 along the longitudinal axis L_{A}. Adjusting the relative housing distance D_{RH} between the first part, which in a preferred embodiment is the housing lid 232, with respect to the second housing part, which in a preferred embodiment is the housing body 234, adjusts the relative gap distance G between the stationary disc 300 and the rotating disc 500, and the first cutting surface 301 and the second cutting surface 502, which in turn adjusts the size of the particles, namely the reduced material 11, emanating from the disc mill assembly 200 and the reducing apparatus 100 as a whole.

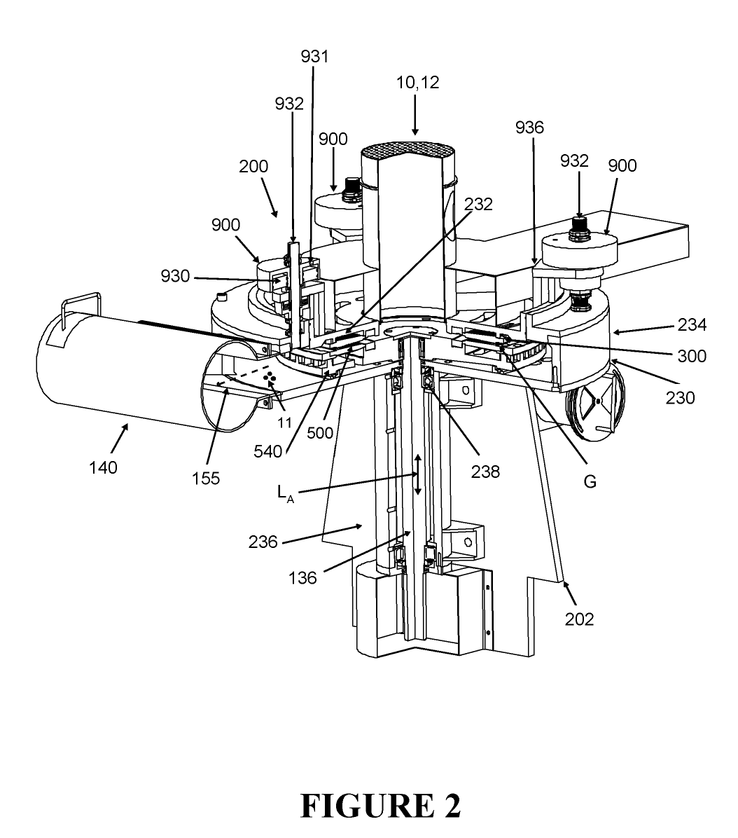

The reducing apparatus 100 also comprises a motor 132 which, through pulley 134 and sheave bushings 137, rotates a rotating shaft 136 about a longitudinal axis L_{A}. In a preferred embodiment, the motor 132 and mill assembly 200 are supported on a common mill base 138. The rotating shaft 136 is housed in a rotating shaft housing 236 (shown in FIG. 2). The rotating disc 500 is generally connected to a carrying plate 540 which is rotated by a rotating shaft 136 as shown in FIG. 1B and FIG. 2. The carrying plate 540 and the rotating shaft 136 are rotatably fixed to the housing body 234 such as by bearing block 238, or other means. In this way, the rotating disc 500 and the rotating cutting surface 502 are at a constant position and distance from the second part, in this preferred embodiment the housing body 234, while the second cutting surface 502 operatively interacts with the first cutting surface 301. Accordingly, it is understood that the first part, which in a preferred embodiment is the housing lid 232, is fixed with respect to the first or stationary disc 300, and the second part, which in a preferred embodiment is the housing body 234, is a part of the housing 230 and/or the mill assembly 200 that is rotatably fixed to the rotating disc 500 and/or at a constant position with respect to the rotating disc 500 and the rotating cutting surface 502 such that relative movement of the first part or housing lid 232 with respect to the second part or housing body 234 would cause relative longitudinal movement of the first cutting surface 301 with respect to the second cutting surface 502. While the present invention has been described in the preferred embodiment with the first part being the housing lid 232 second part being the housing body 234, it is understood that any components of the housing 230 or the disc mill assembly 200 as a whole which have these properties could also act as the first part/housing lid 232 or second part/housing body 234.

The reducing apparatus 100 further comprises a fan 150 which creates a negative air pressure in the duct 140 and causes air to flow along a path, shown generally by the dashed arrow identified by reference numeral 155. The input material 10 is inputted though the top of the disc mill assembly 200 as shown in FIGS. 1A and 1B and emanates through the duct 140 as reduced material 11. The reduced material 11 may comprise finished material 13, as well as course material 12, which could be returned for further processing by the disc mill assembly 200, as discussed further below.

The reduced material 11 from the mill housing 230 is entrained in the air flow 155 created by the fan 150 and is thereby removed from the mill assembly 200 through the duct 140. The reduced material 11 is generally entrained in the air flow 155 and passes through the duct 140 to a cyclone 142. For ease of illustration, the complete duct 140 from the mill housing 230 to the entrance of the cyclone 142 has been omitted. Once the reduced material 11 passes through the cyclone 142 and a rotary valve 143, the reduced material 11 may be separated by means of a sifter 144 into course material 12 and finished material 13. The sifter 144 will direct the properly reduced material 11, or “finished” material 13, to the “finished” material chute 148 where it may be stored in a finished material box 130 and used as required. Any reduced material 11 that has not been properly reduced and is considered course material 12, is sent to the “course” or “oversized” material chute 146 and reintroduced to the disc mill assembly 200. Alternate arrangements could have the course material chute 146 feeding the course material 12 back to the funnel 122 to be reintroduced with raw material 10. In either case, the course material 12 can be further processed in the disc mill assembly 200, with or without new input material 10.

A controller 1600 is shown in FIG. 1A to control the reducing machine 100 and may comprise various sensors, such as temperature sensors (not shown) to sense the temperature of the reducing apparatus 100 and/or the disc mill assembly 200 at different locations. In a preferred embodiment. the controller 1600 is shown generally in FIG. 1A as a single program logic controller 1600, but it is understood that the controller 1600 of the reducing apparatus 100 could have discrete controllers at different locations of the reducing apparatus 100 controlling and/or sensing different operational aspects of the apparatus 100 which conceptually would be equivalent to the controller 1600 shown in FIG. 1A.

In a preferred embodiment, the reducing apparatus 100 shown in FIG. 1A further comprises a gap adjusting system, shown generally by reference numeral 800. The gap adjusting system 800 adjusts the relative gap distance G and thus adjusts the size of particles such as the reducing material 11, emanating from the disc mill assembly 200. In a preferred embodiment, the gap adjusting system 800 may comprise the gap adjusting mechanism 900 and the controller 1600. In this case, the controller 1600 may include programming logic to operate the gap adjusting system 800, or alternatively, the controller 1600 may have a discrete or separate part to operate the gap adjusting system 800. In either case, the controller 1600 will send a gap adjusting signal, shown generally by reference numeral S_{GA}, to the gap adjusting mechanism 900 to adjust the relative gap distance G.

In a preferred embodiment as illustrated in FIG. 1A, the gap adjusting mechanism 900 comprises pneumatically actuated pistons, shown generally by reference numeral 930, and thus the gap adjusting signal S_{GA} would cause a fully automatic pressure regulator 950 to increase or decrease the pneumatic pressure P_{F} to the pneumatic pistons 930 of each of the gap adjusting mechanisms 900, as discussed more fully below. It is understood that the gap adjusting signal S_{GA} may be sent by the single controller 1600 which controls the overall reducing apparatus 100, or, the gap adjusting signal S_{GA} may be sent by a controller 1600 solely for controlling the gap adjusting mechanism 900. Furthermore, in certain preferred embodiments, the controller 1600 may be associated with the fully automatic pressure regulator 950 which sends the gap adjusting signal S_{GA} to the adjusting mechanisms 900 by setting a desired pneumatic pressure P_{F} of the pressure regulator 950 where the adjusting mechanisms 900 comprise pneumatic pistons.

In a preferred embodiment, the gap adjusting system 800 may further comprise a particle size distribution analyzer 1700. The analyzer 1700 may comprise a sensor 1701 which detects a size of particles emanating from the reducing apparatus 100. It is understood that the particle size detection analyzer 1700 may detect the particles emanating directly from the mill housing 230, such as the reduced material 11 from the duct 140, or, in other cases, such as where the reducing machine 100 has a sifter 144, the particle size detection analyzer 1700 may detect the size of finished material 13 that have passed through the sifter 144 and are passing though the finished material chute 148. In either case, the particle size distribution analyzer 1700 will generate a detection signal, shown generally by reference numeral S_{D}, indicative of the detected size of particles and will send the detection signal S_{D} to the controller 1600. The detected size of particles will depend upon the size of the reduced material 11 emanating from the disc mill assembly 200, and, therefore the relative gap distance G.

The controller 1600 receives the detection signal S_{D} and compares the detected size of particles indicated by the detection signal S_{D} to a desired particle size distribution. In a preferred embodiment, the controller 1600 has an input/output 1610 to permit a user to input the desired particle size distribution. The desired particle size distribution may be a specific desired particle size, or a distribution of particle size, as is known in the art. When the controller 1600 receives the detection signal S_{D} and compares the detected size of particles indicated by the detection signal S_{D} to the desired particle size distribution, the controller 1600 sends the gap adjusting signal S_{GA} to adjust the relative housing distance D_{RH} between the first housing part or housing lid 232 and the second part or housing body 234 thereby adjusting the relative gap distance G between the first disc 300 and the second disc 500 based on the comparison of the detected size of particles indicated by the detection signal S_{D} and the desired particle size distribution inputted by the user to the input/output 1610, or previously programmed into the controller 1600.

As illustrated by the arrows, identified generally by reference numeral 902, the gap adjusting mechanism 900 will move the first part or housing lid 232 with respect to the second part or housing body 234 in a first or second direction, to adjust the relative housing distance D_{RH}, as shown more fully in FIG. 1B. This in turn adjusts the relative gap distance G between the first cutting surface 301 of the stationary disc 300 and a second cutting surface 502 of the rotating disc 500. In this way, adjusting the relative housing distance D_{RH} adjusts the relative gap distance G between the first cutting surface 301 of the stationary disc 300 and the second cutting surface 502 of the rotating disc 500, and in turn adjusts the particle size of the reduced material 11 emanating from the disc mill assembly 200.

It is understood that the adjusting mechanism 900 shown by the dashed box in FIGS. 1A and 1B may be any type of adjusting mechanism which can adjust the relative housing distance D_{RH} along the longitudinal axis L_{A} of the first part/housing lid 232 with respect to the second part/housing body 234 in response to the gap adjusting signal S_{GA} from the controller 1600. While in a preferred embodiment the gap adjusting mechanism 900 is pneumatically controlled with pneumatic pressure P_{F} from the fully automatic pressure regulator 950 based on the gap adjusting signal S_{GA} from the controller 1600, it is understood that any type of adjusting mechanism 900 which can adjust the relative housing distance D_{RH} between the first and second parts 232, 234 could be used. For instance, the adjusting mechanism 900 may comprise at least one servo motor 1030 which is actuated by the gap adjusting signal S_{GA} from the controller 1600 to adjust the relative housing distance D_{RH} between the first part/housing lid 232 and the second part/housing body 234 thereby adjusting the relative gap distance G between the first cutting surface 301 and the second cutting surface 502 to adjust the size of the reduced material 11 emanating from the disc mill assembly 200.

FIG. 2 illustrates the disc mill assembly 200 according to one preferred embodiment of the invention with a quarter section removed for ease of illustration. As illustrated in FIG. 2, the stationary disc 300 is separated from the rotating disc 500 by the relative gap distance G. Furthermore, in the embodiment illustrated in FIG. 2, there are three adjusting mechanisms 900 shown at equidistant radial positions around the housing 230. As illustrated in FIG. 2, each adjusting mechanism has a guide pin 932 which is connected to the second part/housing body 234 and a bracket 936 which is connected to the first part/housing lid 232. The bracket 936 is translationally mounted to the guide pin 932 permitting relative translational movement, in this case, parallel to the longitudinal axis L_{A}, of the bracket 936 connected to the first part 232 with respect to the guide pin 932 connected to the second part 234. In the preferred embodiment illustrated in FIG. 2, the relative motion of the bracket 936 with respect to the guide pin 932 is caused by the pneumatically actuated piston 930, however, it is understood that other types of adjusting mechanisms 900, such as electrical or magnetic, could be used.

In a preferred embodiment illustrated in FIG. 2, the pneumatic actuated pistons 930 each have a pneumatic pressure opening 931 where pneumatic force P_{F} may be applied to cause the relative translational movement of the bracket 936 with respect to the guide pin 932. The pneumatic force P_{F} could emanate, in a preferred embodiment, from the fully automatic pressure regulator 950 in response to the gap adjusting signal S_{GA}. It is understood the fully automatic pressure regulator 950 is intended to ensure that the same amount of pneumatic force P_{F} is applied to each of the pneumatically actuated pistons 930 and could be replaced by other means to perform the same function. After calibration with the calibration mechanism 970 (as discussed more fully below), it is understood the fully automated pressure regulator 950 ensures that the substantially same amount of pneumatic force P_{F} is applied to each of the pneumatically actuated pistons 930 when the pneumatic pressure P_{F} is changing so that each of the adjusting mechanisms 900 substantially simultaneously adjusts the relative housing distance D_{RH} to maintain the stationary disc 300 substantially parallel to the rotating disc 500.

As also illustrated in FIG. 2, the input material 10 and/or course material 12 enters through the top of the disc mill assembly 200, which is shown in cross section in FIG. 2, with the other components of the reducing apparatus 100 removed for ease of illustration. The input material 10 and/or course material 12 will pass down towards the rotating disc 500 and then be disbursed radially outwardly by the centripetal force caused by rotation of the rotating disc 500. As the material 10, 12 passes radially outwardly between the opposed discs 300, 500, it will be reduced by the operative interaction of the first cutting surface 301 of the stationary disc 300 and the second cutting surface 502 of the rotating disc 500. The reduced material 11 will then be entrained in the air flow 155 and pass through the housing 230 to the duct 140. The relative gap distance G between the stationary disc 300 and the rotating disc 500 separates the first cutting surface 301 from the second cutting surface 502 which affects the size of the particles, namely the reduced material 11, emanating from the disc housing 230 and ultimately from the reducing apparatus 100 as the finished material 13. As discussed above, adjusting the relative gap distance G will adjust the size of the particles, namely the reduced material 11, emanating from the disc mill 200 and ultimately the particle size of the finished material 13 emanating from the reducing apparatus 100.

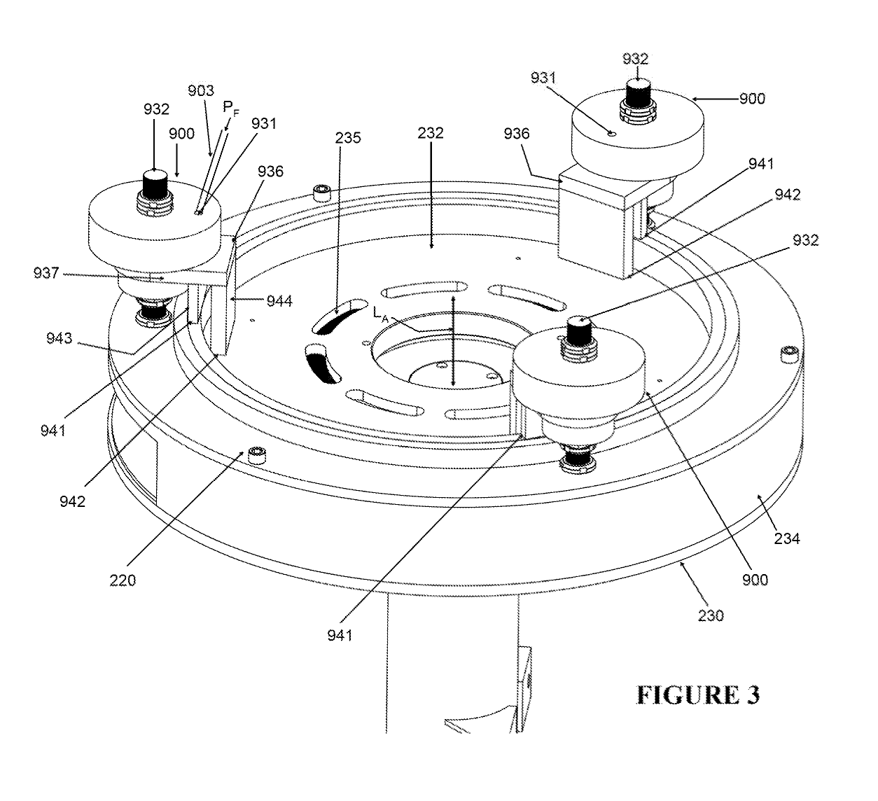

As shown in FIG. 2, as well as in FIG. 3, in a preferred embodiment, there are at least three adjusting mechanisms 900. Preferably, each adjusting mechanism 900 is located at radially equally spaced distances about the mill housing 230. For instance, as illustrated in FIGS. 2 and 3, in the preferred embodiment where there are three adjusting mechanisms 900, they are separated by about 120 degrees about the circumference of the disc housing 230. By separating the adjusting mechanisms 900 equally about the housing 230, it is more likely the stationary disc 300 will be maintained substantially parallel to the rotating disc 500 as the adjusting mechanisms 900 substantially synchronously adjusts the relative housing distance D_{RH} between the housing lid 232 and the housing body 234.

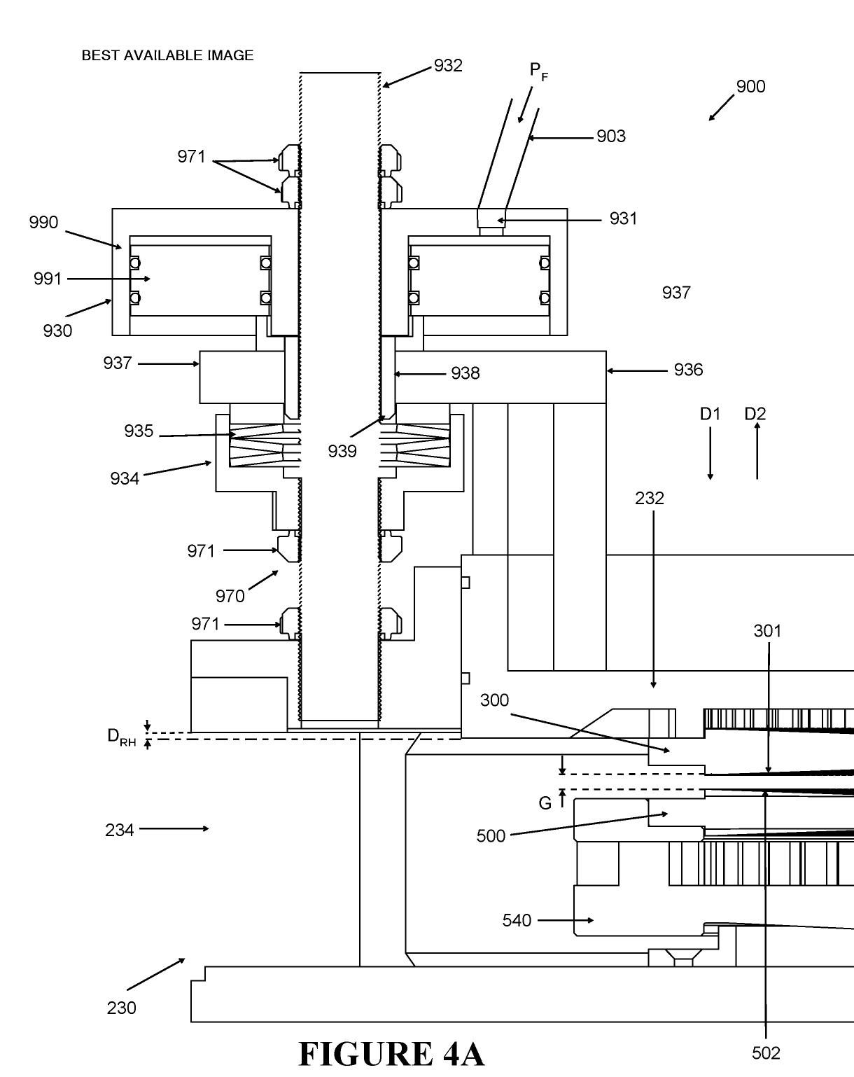

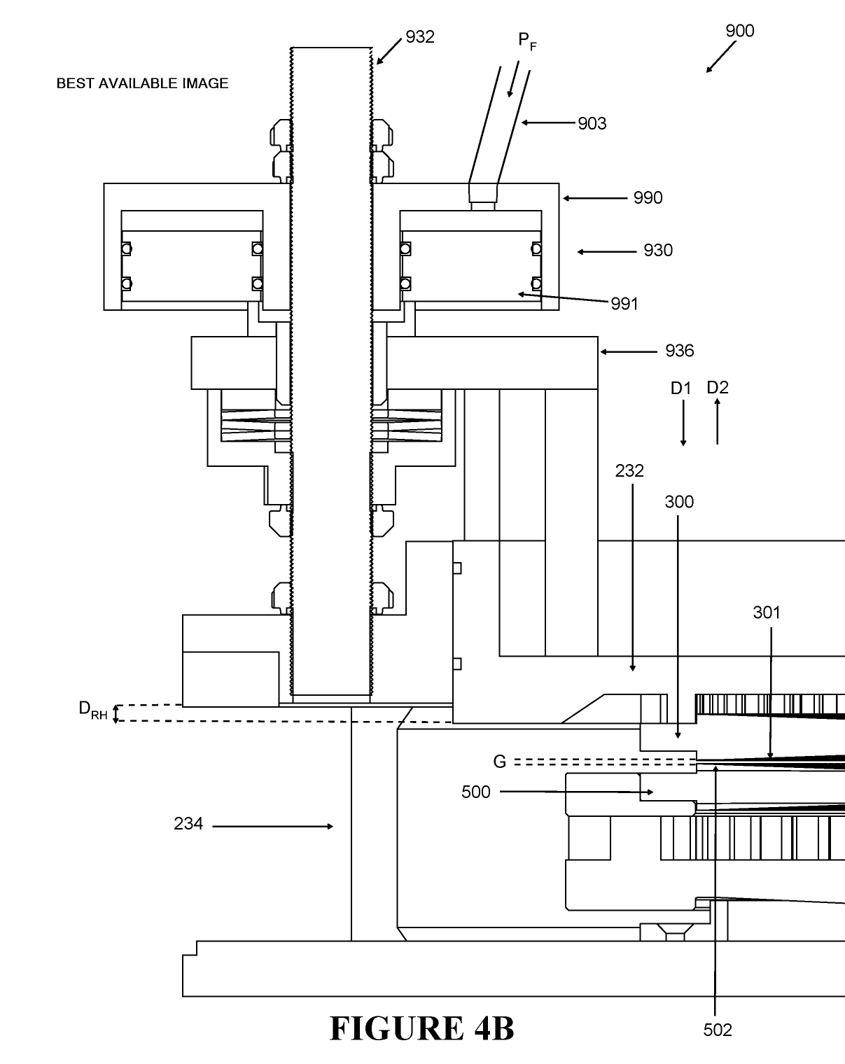

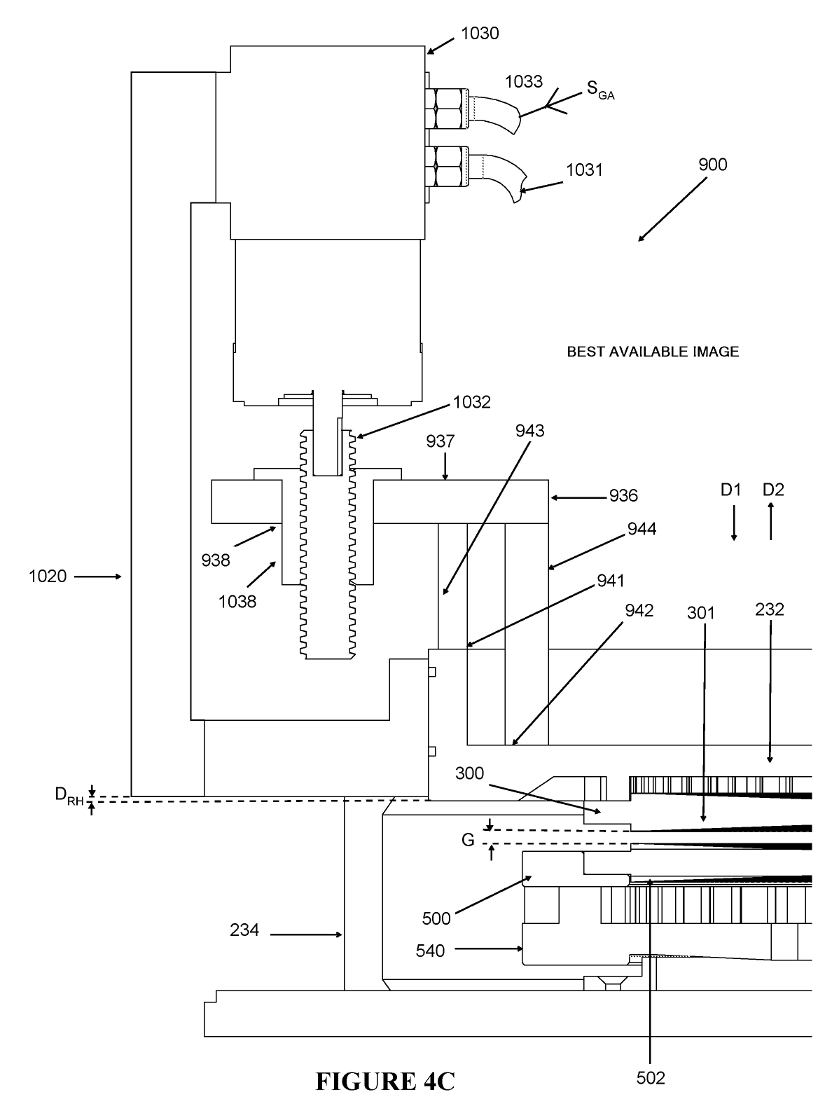

As also illustrated in FIGS. 2 and 3, in a preferred embodiment, the guide pin 932 of each adjusting mechanism 900 is connected to the housing body 234. The guide pin 932 will likely support most of the force of the adjusting mechanism 900 and therefore it is preferred if the guide pin 932 is connected to the housing body 234 which is more sturdily connected to the mill assembly 200 and in particular the disc mill support 202. The bracket 936 of each adjusting mechanism 900 is preferably connected to the housing lid 232 as shown in FIGS. 2 and 3, and translationally mounted to the guide pin 932. This can occur for instance by a bushing 939 (see FIG. 4A) or other known means to permit relative translational movement of the bracket 936 with respect to the guide pin 932.

In a preferred embodiment, each bracket 936 is connected to the housing lid 232 at two points of contact, shown generally by reference numerals 941, 942 in FIG. 3. More preferably, the two points of contact 941, 942 are not co-planar. In other words, as illustrated in FIG. 3, the first point of contact 941 is at a different longitudinal position along the longitudinal axis L_{A} than the second point of contact 942. This is done to provide a more stable connection between the bracket 936 and the housing lid 232. Moreover, having two points of contact 941, 942 between the bracket 936 and the housing lid 232, and in particular points of contact 941, 942 that are at a different longitudinal positions along the longitudinal axis L_{A}, provides more stable translational movement of the housing lid 232, and by extension the stationary disc 300 connected thereto, along the longitudinal axis L_{A}. As discussed above, the housing lid 232 is moved relative to the housing body 234 to adjust the relative housing distance D_{RH} along the longitudinal axis L_{A} to thereby adjust the relative gap distance G between the first cutting surface 301 and the second cutting surface 502.

FIG. 3 also illustrates other components of the disc mill assembly 200. For instance air inlets 235 in the housing lid 232 permit air to enter behind the stationary disc 300 for cooling as is described more fully in US Application No. US 2015/0076262. However, it is understood that the gap adjusting mechanism 900 may operate with different types of mill assemblies 200 installed in various types of reducing apparatus 100, and is not limited to being used with the specific mill assembly 200 and reducing apparatus 100 illustrated in this preferred embodiment.

FIG. 3 also shows each of the adjusting mechanisms 900 having a pneumatic pressure opening 931, which in a preferred embodiment where the adjusting mechanism 900, comprises a pneumatically actuated piston 930. The pneumatic pressure opening 931 would be connected to a hose, or other device, through which pneumatic pressure P_{F} may enter the pneumatically actuated piston 930 to cause relative translational movement of the bracket 936 with respect to the guide pin 932 in response to the gap adjusting signal S_{GA} increasing pneumatic pressure P_{F} through the fully automatic pressure regulator 950. It would be preferred if the pneumatic pressure P_{F} be applied equally to each of the adjusting mechanisms 900 as illustrated in FIG. 3 to permit substantially simultaneous transitional movement of each of the brackets 936 with respect to each of the guide pins 932. For ease of illustration, a hose 903 is only shown connected to one of the pneumatic pressure openings 931.

Additional components of the adjusting mechanism 900 according to one preferred embodiment are further illustrated in FIG. 4A and FIG. 4B. FIG. 4A shows the pneumatically actuated piston 930 at a lower pneumatic pressure P_{F} and FIG. 4B shows the pneumatically actuated piston 930 at a higher pneumatic pressure P_{F}. Comparing FIGS. 4A and 4B, it is apparent that in FIG. 4A, when the pneumatic pressure P_{F} is lower, the relative housing distance D_{RH}, as well as the relative gap distance G, is greater than when the pneumatic pressure P_{F} is greater as shown in FIG. 4B, where the relative housing distance D_{RH} and the relative gap distance G decreases.

As illustrated in FIGS. 4A and 4B, the adjusting mechanism 900, which in a preferred embodiment comprises a pneumatically actuated piston 930, has a piston chamber 990 which may be cylindrical and a pneumatic piston 991 which may have O-rings, and/or other components to permit movement of the pneumatic piston 991 within the pneumatic chamber 990. As pneumatic pressure P_{F} increases in the pneumatic chamber 990, such as resulting from the gap adjusting signal S_{GA} from the controller 1600 activating the regulator 950 to increase the pneumatic pressure P_{F}, fluid, such as air, but other fluids such as oil or water being possible, will enter the chamber 990, increasing the pressure P_{F} and moving the piston 991 lower. This causes relative translational movement of the bracket 936 with respect to the guide pin 932 in a first direction D1 moving the bracket 936 downwards along the longitudinal axis L_{A} and decreasing the relative housing distance D_{RH} and the relative gap distance G. To increase the relative gap distance G, the controller 1600 sends a gap adjusting signal S_{GA} which decreases the pneumatic pressure P_{F}. In this case, in a preferred embodiment, a biasing member, shown generally by reference number 934, may cause translational movement of the bracket 936 relative to the guide pin 932 in a second direction D2 parallel the longitudinal axis L_{A} and opposite to the first direction D1. In this way the biasing member 934 causes translational movement of the bracket 936 upward and increases the relative housing distance D_{RH} and the relative gap distance G. In a preferred embodiment, the biasing member 934 comprises a spring, shown generally by reference numeral 935, which applies a predetermined biasing force on radial member 937 of the bracket 936 along the longitudinal axis L_{A}.

As illustrated in FIGS. 2, 4A and 4B, in a preferred embodiment, the bracket 936 has an orifice 938 in the radial member 937. The bracket 936 also has longitudinal portions 943, 944 emanating from the radial member 937 which connect to the first and second points 941, 942 of the housing lid 232 respectively. In a preferred embodiment a bushing 939, which may be made of brass, is placed about the inner circumference of the orifice 938 to facilitate the translational movement of the bracket 936 with respect to the guide pin 932. It is understood the guide pin 932 may be threaded for easier assembly of other components thereto.

In a further preferred embodiment, each adjusting mechanism 900 further comprises a calibrating mechanism, shown generally by reference numeral 970. The calibrating mechanism 970 is used to initially calibrate each of the adjusting mechanisms 900 such that the stationary disc 300 is parallel to the rotating disc 500 at an initial common pneumatic pressure P_{F} in the pneumatically actuated pistons 930. In other words, at the initial calibration, a known amount of pressure P_{F} is applied by the regulator 950 to each of the pneumatically actuated pistons 930. The calibrating mechanism 970, which in one preferred embodiment comprises calibrating nuts 971, is then adjusted to ensure that the stationary disc 300 is substantially parallel to the rotating disc 500, and also preferably at a correct or preferred initial relative gap distance G. In this way, the gap adjusting signal S_{GA} may in the future increase and decrease the pneumatic pressure P_{F} through the regulator 950 to permit an acceptable range of translational movement of the bracket 936 with respect to the guide pin 932 so that each of the adjusting mechanisms 900 substantially simultaneously adjust the relative housing distance D_{RH} between the first part/housing lid 232 and the second part/housing body 234 and the relative gap distance G between the discs 300, 500 as well as the cutting surfaces 301, 502 in an adequate adjustment range of the relative gap distance G while maintaining the stationary disc 300 parallel to the rotating disc 500.

FIG. 4C shows a further preferred embodiment of an adjusting mechanism 900 comprising a servo motor, shown generally by reference numeral 1030, used to cause a relative translational movement of the bracket 936 with respect to a servo guide pin, shown generally by reference numeral 1032. In this embodiment, rotation of the servo guide pin 1032 by the servo motor 1030 causes relative translational movement with the bracket 936. For example, as illustrated in FIG. 4C, rotating the servo guide pin 1032 in a first rotation direction will cause relative translational movement of the bracket 936 downwards along the longitudinal axis L_{A} in a first direction D1 decreasing the relative housing distance D_{RH} between the first part/housing lid 232 and the second part/housing body 234 and decreasing the relative gap distance G. Similarly, the servo motor 1030 may rotate the servo guide pin 1032 in a second rotation direction opposite the first rotation direction, which will cause relative translational movement of the bracket 936 with respect to the servo guide pin 1032 upwards along the longitudinal axis L_{A} in a second direction D2 increasing the relative housing distance D_{RH} between the first part/housing lid 232 and the second part/housing body 234 thereby increasing the relative gap distance G.

The servo motor 1030 is connected to a power line, shown generally by reference numeral 1031, to provide power to the servo motor 1030 permitting rotation of the servo guide pin 1032. The servo motor 1030 also receives the gap adjusting signal S_{GA} from the controller 1600 preferably through line 1033, but it is understood that a wireless connection could also be used.

As illustrated in FIG. 4C, the bracket 936 is still connected to the housing lid 232 at two points of contact, shown generally by reference numeral 941, 942. The bracket 936 preferably has the orifice 938 in the radial member 937, but the orifice 938 preferably has a threaded element 1038 which cooperatively interacts with the threads of the servo guide pin 1032 to convert the rotation of the servo guide pin 1032 into relative translational movement of the bracket 936 with respect to the servo guide pin 1032. It is understood the threads in FIG. 4C have been exaggerated for ease of illustration. In a preferred embodiment, the servo motor 1030 is connected to a fixed element of the disc mill assembly 200 to provide the appropriate support and more preferably, the servo motor 1030 may be fixed to the second part/housing body 234 as illustrated in FIG. 4C by means of the bracket 1020.

In this way, the servo motor 1030 may receive the gap adjusting signal S_{GA} which causes the servo motor 1030 to rotate the servo guide pin 1032. The threads on the servo guide pin 1032 then interact with the threads of threaded element 1038 attached to the orifice of the bracket 936 causing the bracket 936 to transitionally move with respect to the servo guide pin 1032 in the first direction D1 or the second direction D2. In this way, the relative housing distance D_{RH} may be adjusted thereby adjusting the relative gap distance G between the first cutting surface 301 and the second cutting surface 502.

Accordingly, it is understood the adjusting mechanism 900 may have a pneumatically actuated piston 930 (shown in FIGS. 4A and 4B), but the adjusting mechanism 900 may also have other types of actuating mechanisms, such as the servo motor 1030 (shown in FIG. 4C) or any other types of actuating mechanism to cause the adjusting mechanism 900 to operate as described herein.

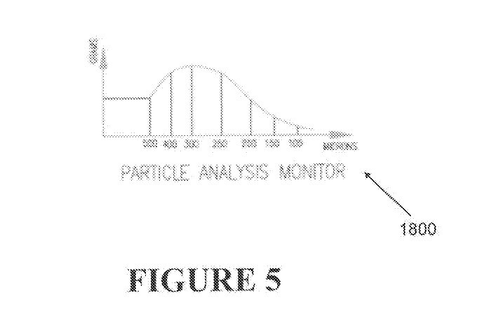

It is understood that the gap adjusting system 800, through the particle size distribution analyzer 1700, would be able to monitor to size of the particles emanating from the reducing apparatus 100 as the finished particles 13, as discussed above. FIG. 5 illustrates one exemplary output of a particle size distribution analyzer 1700. The detection signal S_{D} will be indicative of the outputted detected size of particles 1800 emanating from the analyzer 1700 and as exemplified in FIG. 5. Furthermore, in a preferred embodiment, the user may input a corresponding desired particle size distribution (not shown) into the input 1610 of the controller 1600. The controller 1600 will then generate and send the gap adjusting signal S_{GA} to each of the adjusting mechanisms 900 to adjust the relative housing distance D_{RH} between the first part or housing lid 232 and the second part or housing body 234 to thereby adjust the relative gap distance G between the first disc 300 and the second disc 500 based on a comparison of the outputted detected size particles 1800, as indicated by the detection signal S_{D}, and the desired particle size distribution inputted at the controller 1600, so that the detected particle size distribution approaches the desired particle size distribution inputted at the controller 1600. In this way, closed loop control of the relative gap distance G may be provided to approach a desired particle size distribution as inputted to the controller 1600. Furthermore, overtime, the controller 1600 may be programmed to learn, such as through artificial intelligence software, that a specific known gap adjusting signal S_{GA} will generate a corresponding known outputted detected size of particles 1800.

It is also understood that the adjustment of the relative gap distance G by the gap adjusting system 800 may occur without dismantling the mill housing 230 and possibly while the reducing apparatus 100 is functionally operational. Furthermore, if during operation a change in the desired particle size distribution is desired, the user may input a different desired particles size distribution into the controller 1600 and the process will be repeated until the controller 1600 has sent a gap adjusting signal S_{GA} to each of the adjusting mechanisms 900 to adjust the relative housing distance D_{RH}, and the corresponding relative gap distance G between the first disc 300 and the second disc 500, to at least approach the new desired particle size distribution. In a preferred embodiment, this may be done without dismantling the housing 230 and, in fact, may be done without necessarily stopping the reducing apparatus 100.

It is understood that while reference has been made to a pneumatic system utilizing air then any type of pneumatic system could be used. In particular, a pneumatic system using other types of fluid, such as water or other fluids such as oil, with different densities or viscosity, may also be used to provide sufficient resolution.

To the extent that a patentee may act as its own lexicographer under applicable law, it is hereby further directed that all words appearing in the claims section, except for the above defined words, shall take on their ordinary, plain and accustomed meanings (as generally evidenced, inter alia, by dictionaries and/or technical lexicons), and shall not be considered to be specially defined in this specification. Notwithstanding this limitation on the inference of “special definitions,” the specification may be used to evidence the appropriate, ordinary, plain and accustomed meanings (as generally evidenced, inter alia, by dictionaries and/or technical lexicons), in the situation where a word or term used in the claims has more than one pre-established meaning and the specification is helpful in choosing between the alternatives.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments, which are functional, electrical or mechanical equivalents of the specific embodiments and features that have been described and illustrated herein.

The embodiments of the invention in which an exclusive property or privilege is claimed are defined as follows:

1. A disc mill assembly of a reducing apparatus, said disc mill assembly comprising:
a disc mill housing for housing a first disc having a first cutting surface and a second disc having a second cutting surface, said first cutting surface separated from said second cutting surface by a relative gap distance along a longitudinal axis, said first cutting surface in operative interaction with the second cutting surface to reduce input material, said disc mill housing having a first part, operable to be connected to the first disc, and a second part a constant position and distance from the second cutting surface of the second disc;
at least one adjusting mechanism associated with the housing for adjusting a relative housing distance along the longitudinal axis of the first part with respect to the second part in response to a gap adjusting signal;
a controller for sending the gap adjusting signal to each of the adjusting mechanisms; and
wherein the controller sending the gap adjusting signal to each of the adjusting mechanisms causes each of the adjusting mechanisms to adjust the relative housing distance between the first part and the second part to thereby adjust the relative gap distance between the first cutting surface and the second cutting surface.

2. The disc mill assembly as defined in claim 1, wherein the first part is a housing lid of the disc mill housing and the first disc is a stationary disc;
wherein the second part is a housing body of the disc mill housing;
wherein the second disc is a rotating disc rotatably attached to the housing body for rotating within the disc mill housing with the first cutting surface of the stationary disc separated from the second cutting surface of the rotating disc by the relative gap distance.

3. The disc mill assembly as defined in claim 1, wherein each adjusting mechanism comprises a pneumatically actuated piston which is actuated by the gap adjusting signal from the controller to adjust the relative housing distance between the first part and the second part to adjust the relative gap distance between the first cutting surface and the second cutting surface.

4. The disc mill assembly as defined in claim 1, wherein a particle size detection analyzer for detecting a size of particles emanating from the reducing apparatus and generates a detection signal indicative of the detected size of particles;
wherein the controller receives the detection signal and compares the detected size of particles indicated by the detection signal to a desired particle size distribution;
wherein the controller sends the gap adjusting signal to each of the adjusting mechanisms to adjust the relative housing distance between the first part and the second part thereby adjusting the relative gap distance between the first disc and the second disc based on the comparison of the detected size of particles indicated by the detection signal and the desired particle size distribution.

5. The disc mill assembly as defined in claim 1, wherein each adjusting mechanism comprises:
a guide pin connected to the second part;
a bracket translationally mounted to the guide pin and connected to the first part;
wherein the gap adjusting signal causes the adjusting mechanism to move the bracket with respect to the guide pin thereby adjusting the relative housing distance between the first part and the second part and adjusting the relative gap distance between the first cutting surface and the second cutting surface.

6. The disc mill assembly as defined in claim 5 wherein each adjusting mechanism further comprises:
a pneumatically actuated piston for causing relative translational motion of the bracket with respect to the guide pin in response to the gap adjusting signal increasing pneumatic pressure in the pneumatically actuated piston.

7. This disc mill assembly as defined in claim 6, wherein each adjusting mechanism further comprises a biasing member for causing relative translational movement of the bracket with respect to the guide pin in response to the gap adjusting signal decreasing pneumatic pressure in the pneumatically actuated piston.

8. The disc mill assembly as defined in claim 7, wherein each adjusting mechanism further comprises a calibrating mechanism to initially calibrate each of the adjusting mechanisms such that the first disc is parallel to the second disc at an initial pneumatic pressure in each of the pneumatically actuated pistons.

9. The disc mill assembly as defined in claim 1, wherein each adjusting mechanism comprises at least one servo motor which is actuated by the gap adjusting signal from the controller to adjust the relative housing distance between the first part and the second part thereby adjusting the relative gap distance between the first cutting surface and the second cutting surface.

10. In a disc mill assembly of a reducing apparatus, said disc mill assembly having a housing with a housing lid operable to be connected to a stationary disc and a housing body operable to be rotatably connected to a rotating disc in operative interaction to the stationary disc and separated therefrom by a relative gap distance along a longitudinal axis to reduce input material there between, a gap adjusting system for adjusting the relative gap distance, said gap adjusting system comprising:
at least one adjusting mechanism for adjusting a relative housing distance between the housing lid and the housing body along the longitudinal axis in response to a gap adjusting signal;
a controller for sending the gap adjusting signal to each of the at least one adjusting mechanism causing the at least one adjusting mechanism to substantially synchronously adjust the relative housing distance between the housing lid and the housing body to adjust the relative gap distance between the stationary disc and the rotating disc.

11. The gap adjusting system as defined in claim 10, wherein the stationary disc has a stationary cutting surface and the rotating disc has a rotating cutting surface in operative interaction with the stationary cutting surface to reduce input material; and
wherein the gap adjusting system adjusting the relative gap distance between the stationary cutting surface and the rotating cutting surface adjusts the size of particles emanating from the disc mill assembly.

12. The gap adjusting system as defined in claim 11, further comprising:
a particle size detection analyzer for detecting a size of particles emanating from the reducing apparatus and generating a detection signal indicative of the detected size of particles;
wherein the controller receives the detection signal and compares the detected size of particles indicated by the detection signal to a desired particle size distribution;
wherein the controller sends the gap adjusting signal to each of the adjusting mechanisms to adjust the relative housing distance between the discs based on the comparison of the detected size of particles indicated by the detection signal and the desired particle size distribution.

13. The gap adjusting system as defined in claim 12 wherein the controller further comprises an input unit for inputting the desired particle size distribution.

14. The gap adjusting system as defined in claim 10 wherein each adjusting mechanism comprises:
a guide pin connected to the housing body;
a bracket translationally mounted to the guide pin and connected to the housing lid;
wherein the gap adjusting signal causes the adjusting mechanism to translationally move the bracket with respect to the guide pin thereby adjusting the relative housing distance between the housing lid and the housing body to adjust the relative gap distance between the stationary disc and the rotating disc.

15. The gap adjusting system as defined in claim 14, wherein each adjusting mechanism comprises a pneumatically actuated piston for causing relative translational movement of the bracket with respect to the guide pin in a first direction in response to the gap adjusting signal increasing pneumatic pressure in the pneumatically actuated piston to decrease the relative gap distance.

16. The gap adjusting system as defined in claim 15, wherein each adjusting mechanism further comprises a biasing member for causing translational movement of the bracket relative to the guide pin in a second direction, opposite to the first direction, in response to the gap adjusting signal decreasing pneumatic pressure in the pneumatically actuated piston to increase the relative gap distance.

17. The gap adjusting system as defined in claim 16, wherein each adjusting mechanism further comprising:
a calibrating mechanism to initially calibrate each of the adjusting mechanisms such that the stationary disc is parallel to the rotating disc at an initial common pneumatic pressure in each of the pneumatically actuated pistons.

18. The gap adjusting system as defined in claim 10 wherein the at least one adjusting mechanism comprises at least three adjusting mechanisms, each adjusting mechanism located radially spaced equally distant about the mill housing to maintain the stationary disc substantially parallel to the rotating disc as the adjusting mechanism synchronously adjusts the relative housing distance between the housing lid and the housing body.

19. The gap adjusting system as defined in claim 10, wherein the at least one adjusting mechanism comprises at least one servo motor which is actuated by the gap adjusting signal from the controller to adjust the relative housing distance between the stationary disc and the rotating disc.

20. The disc mill assembly as defined in claim 1, wherein the at least one adjusting mechanism comprises at least three adjusting mechanisms, each adjusting mechanism located radially spaced equally distant about the mill housing to maintain the first disc substantially parallel to the second disc as the adjusting mechanisms adjusts the relative housing distance between the first housing part and the second housing part.
